(19) United States
(12) Patent Application Publication
(10) Pub. No.: US 2025/0189324 A1
(43) Pub. Date: Jun. 12, 2025

(54) DRIVING INFORMATION DISPLAY APPARATUS AND METHOD FOR PROVIDING GUIDANCE ON PERSONALIZED ELECTRIC VEHICLE DRIVING ROUTE

(71) Applicants: Hyundai Motor Company, Seoul (KR); Kia Corporation, Seoul (KR); Hyundai Autoever Corp., Seoul (KR)

(72) Inventors: Tae Heon Kim, Hwaseong-si (KR); Jaeseok Park, Hwaseong-si (KR); Geumdan Jin, Hwaseong-si (KR); Taehyun Sung, Hwaseong-si (KR); Hanshik Kim, Hwaseong-si (KR); Sang Jun Lee, Hwaseong-si (KR); WonMi Ahn, Seoul (KR); Jin Young Min, Seoul (KR); HwaHyeon Hong, Seoul (KR); Lam Lee, Seoul (KR)

(21) Appl. No.: 18/960,553

(22) Filed: Nov. 26, 2024

(30) Foreign Application Priority Data
Dec. 6, 2023 (KR) 10-2023-0175379

(51) Int. Cl. G01C 21/34; B60L 58/12; G01C 21/36; G07C 5/04

(52) U.S. Cl. CPC G01C 21/3469; G01C 21/3484; G01C 21/3679; G07C 5/04; B60L 58/12

(57) ABSTRACT

In a driving information display apparatus and method for providing guidance on a personalized electric vehicle driving route, the driving information display apparatus can include a processor configured to perform control to receive driving guidance information and the location information of an electric vehicle and output a guidance screen corresponding to the driving guidance information, and a storage unit configured to store road information and an algorithm run by the processor. The driving guidance information can include route information including a passage via a charging station that is generated by deriving a driving type based on driving information including the destination of the electric vehicle, deriving a weight for each charging factor based on the driving information, and using the derived driving type and the derived weight for each charging factor.

### CROSS-REFERENCE TO RELATED APPLICATIONS

The present application claims priority to Korean Patent Application No. 10-2023-0175379 filed on Dec. 6, 2023, the entire contents of which are incorporated herein for all purposes by this reference.

### TECHNICAL FIELD

The present disclosure relates to a driving information display apparatus and method for providing guidance on a personalized electric vehicle driving route.

### BACKGROUND

Electric vehicles may be difficult to drive comfortably due to long charging times and an insufficient number of charging stations in terms of the characteristics thereof. Accordingly, there is a demand for a route guidance service that considers the battery states of electric vehicles and guides them to charging stations.

In response to the demand, there is disclosed a technology that changes a guidance route by considering a remaining battery charge level at each location while guiding an electric vehicle through the guidance route, such as the technology disclosed in U.S. Pat. No. 9,170,118 entitled “Navigation System for Electric Vehicle.” In this technology, to ensure safe next driving when the electric vehicle arrives at a destination, a target remaining battery charge level at the destination is set, and route guidance used for driving via a charging station is provided to achieve the target remaining battery charge level.

However, when a route is provided so that only the driving to a destination can be completed safely, inconvenience may be experienced during the next drive after arrival at the destination due to an insufficient battery charge level. Therefore, there is a demand for route guidance technology that manages a battery state by considering the next driving.

The information included in this Background of the Present Disclosure is only for enhancement of understanding of the general background of the present disclosure and may not be taken as an acknowledgement or any form of suggestion that this information forms the prior art already publicly known available, or in use.

### SUMMARY

The present disclosure relates to a driving information display apparatus and method for providing guidance on a personalized electric vehicle driving route, and more particularly to a driving information display apparatus and method for providing driving guidance information including route information including a passage via an electric vehicle charging station based on a driver's driving pattern or schedule, and a method of operating the same.

An embodiment of the present disclosure can provide driving guidance information that enables comfortable driving by considering the remaining battery charge level of an electric vehicle.

An embodiment of the present disclosure can improve the overall convenience of driving of an electric vehicle by predicting not only driving to a destination, but also driving after arrival at the destination.

An embodiment of the present disclosure can predict a driving type regarding whether current driving is round-trip driving or one-way driving by analyzing the driving patterns of each driver and provide route guidance appropriate for the driving type.

An embodiment of the present disclosure can provide customized route guidance according to circumstances such as a driver's next schedule even when the driver drives the same route.

The problems to be solved as an example embodiment of the present disclosure are not necessarily limited to the problems described above, and solutions to other problems by an embodiment of the present disclosure may be understood by those skilled in the art from the following detailed description of example embodiments of the present disclosure.

According to various embodiments of the present disclosure, a driving information display apparatus can include: a processor configured to perform control to receive driving guidance information and the location information of an electric vehicle and output a guidance screen corresponding to the driving guidance information; and a storage unit configured to store road information and an algorithm run by the processor, and the driving guidance information can include route information including a passage via a charging station that is generated by deriving a driving type based on driving information including the destination of the electric vehicle, deriving a weight for each charging factor based on the driving information, and using the derived driving type and the derived weight for each charging factor.

The route information may be derived by determining a remaining charge level at the destination based on the derived driving type and the derived weight for each charging factor and including the passage via a charging station to satisfy the determined remaining charge level at the destination.

The remaining charge level at the destination may be determined by predicting the driving next to current driving based on the driving type and reflecting information related to the predicted next driving in the determination.

The remaining charge level at the destination may be determined so that a minimum remaining charge level remains even after additional driving from the destination to the nearest charging station.

The remaining charge level at the destination may be determined so that, when the driving type is round-trip driving, a minimum remaining charge level remains even after the completion of return driving.

The driving type may be derived by entering the driving information of the electric vehicle into a personalized driving-type artificial intelligence model that is generated by performing training using the past driving information of the driver of the electric vehicle as training data.

The weight for each charging factor may be derived by entering the driving information of the electric vehicle into a personalized charging-factor artificial intelligence model that is generated by performing training using the past driving information of the driver of the electric vehicle as training data.

According to various embodiments of the present disclosure, a driving information display apparatus can include a driving information management server equipped with a central processing unit and memory, and the driving information management server can include: a connection setup unit configured to set up connections to exchange information with the driving information display apparatuses of a plurality of electric vehicles; a driving type derivation unit configured to derive a driving type based on driving information including the destination of each of the electric vehicles received from the electric vehicle; a per-charging factor weight derivation unit configured to derive a weight for each charging factor based on the driving information; a route information generation unit configured to generate route information including a passage via a charging station generated using the derived driving type and the derived weight for each charging factor; and a driving guidance information transmission unit configured to transmit driving guidance information including the generated route information to the electric vehicle.

The methods and apparatuses of embodiments of the present disclosure can have other features and advantages that can be apparent from or can be set forth in more detail in the accompanying drawings, which are incorporated herein, and the following Detailed Description, which together serve to explain certain principles of example embodiments of the present disclosure.

### BRIEF DESCRIPTION OF THE DRAWINGS

FIG. 1 is a block diagram showing the internal configuration of a driving information display device according to various example embodiments of the present disclosure;

FIG. 2 is a block diagram showing the internal configuration of a driving information management server according to various example embodiments of the present disclosure;

FIG. 3 is a diagram showing an example of determining a remaining charge level at a destination according to a driving type in a driving information display apparatus according to various example embodiments of the present disclosure;

FIG. 4 is a diagram showing an example of route guidance that can vary depending on the presence/absence of a charging station near a destination in a driving information display apparatus according to various example embodiments of the present disclosure;

FIG. 5 is a diagram showing an example of route guidance that can vary depending on the situation during a round-trip commute drive in a driving information display apparatus according to various example embodiments of the present disclosure;

FIG. 6 is a diagram showing an example of route guidance that can vary depending on the presence/absence of a slow charger at a destination in a driving information display apparatus according to various example embodiments of the present disclosure;

FIG. 7 is a diagram illustrating an example of route guidance that can vary depending on the presence/absence of a schedule after arrival at a destination in a driving information display apparatus according to various example embodiments of the present disclosure;

FIG. 8 is a diagram showing the flow of a process of generating route guidance by classifying a driving type and obtaining a weight for each charging factor in a driving information display apparatus according to various example embodiments of the present disclosure; and

FIG. 9 is a flowchart showing the flow of a driving information display method according to various example embodiments of the present disclosure.

It may be understood that the appended drawings are not necessarily to scale, presenting a somewhat simplified representation of various features illustrative of the basic principles of the example embodiments of the present disclosure. The specific design features of the example embodiments of the present disclosure as included herein, including, for example, specific dimensions, orientations, locations, and shapes can be determined in part by the particularly intended application and use environment.

In the figures, reference numbers can refer to same or equivalent parts of example embodiments of the present disclosure throughout the several figures of the drawing.

### DETAILED DESCRIPTION OF ILLUSTRATIVE EMBODIMENTS

Reference will now be made in detail to various embodiments of the present disclosure, which are illustrated in the accompanying drawings and described below. While the present disclosure will be described in conjunction with example embodiments of the present disclosure, it can be understood that the present description is not intended to necessarily limit the present disclosure to those example embodiments of the present disclosure. On the other hand, the present disclosure is intended to cover not only the example embodiments of the present disclosure, but also various alternatives, modifications, equivalents and other embodiments, which may be included within the spirit and scopes of the present disclosure as defined by the appended claims.

Example embodiments of the present disclosure will be described in detail below with reference to the accompanying drawings. In the following description of example embodiments of the present disclosure, when it is determined that a detailed description of any related known configuration or function may obscure the gist of the present disclosure, the detailed description can be omitted. In the following description of the example embodiments of the present disclosure, specific numerical values are only examples, and the scopes of the present disclosure are not necessarily limited thereby.

In the following descriptions of the components of the example embodiments of the present disclosure, terms such as “first,” “second,” “A,” “B,” “(a),” “(b),” and so forth, may be used. These terms can be used merely to distinguish corresponding components from other components, and the natures, sequential positions, and/or orders of the corresponding components are not necessarily limited by these terms. Unless defined otherwise, terms used herein, including technical or scientific terms, can include a same meaning as commonly understood by those skilled in the art to which an example embodiment of the present disclosure pertains. Terms such as those defined in commonly used dictionaries can be interpreted as having meanings consistent with the meanings in the context of related art, and should not be interpreted as having ideal or excessively formal meanings unless explicitly defined in the present application.

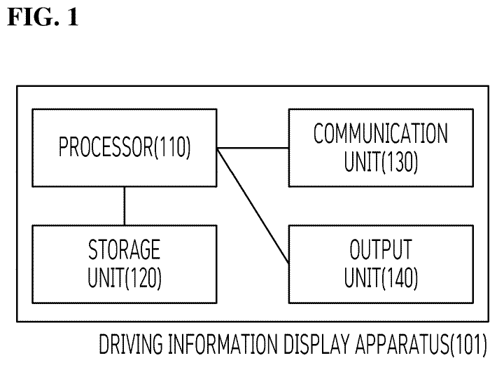

Example embodiments of the present disclosure will be described in detail below with reference to FIGS. 1 to 9.

FIG. 1 is a block diagram showing the internal configuration of a driving information display apparatus 101 according to various example embodiments of the present disclosure.

The driving information display apparatus 101 according to the example embodiment may be provided inside a transportation system such as a vehicle, or may be implemented in a detachable form. The driving information display apparatus 101 may generally include the form of a vehicle navigation system, an audio, video and navigation (AVN) system, a head-up display (HUD), or the like, and may be implemented in a form in which an application is provided on a mobile phone terminal such as a smartphone, for example.

The driving information display apparatus 101 according to the example embodiment may be present in a form of a server outside a transportation system such as a vehicle. The driving information display apparatus 101 may be implemented to generate driving guidance information by processing determinations while being present outside a transportation system and to output the driving guidance information to a display present inside the transportation system. Various embodiments may be implemented. The scope of rights of the present disclosure is not necessarily limited by the forms of such implementations.

The driving information display apparatus 101 of the example embodiment may operate in conjunction with devices for autonomous driving control such as an advanced driver assistance system (ADAS), a smart cruise control (SCC) system, a forward collision warning (FCW) system, and/or the like.

As shown in the drawing, the driving information display apparatus 101 according to the example embodiment may include a processor 110, a storage unit 120, a communication unit 130, and an output unit 140.

The processor 110 can be configured to control the storage unit 120, the communication unit 130, and the output unit 140 to execute an application, process data according to the algorithm defined in the application, communicate with an external module, and provide the results of the processing to a user.

The processor 110 may refer to a chip for processing a general algorithm, such as a central processing unit (CPU) or an application processor (AP), or a set of such chips. The processor 110 may refer to a chip optimized for floating-point arithmetic, such as a general-purpose computing on graphics processing unit (GPGPU), to process an artificial intelligence algorithm such as deep learning, or a set of such chips. Alternatively, the processor 110 may refer to a module in which various types of chips perform an algorithm and process data in a connected and distributed manner.

The processor 110 may be electrically connected to the storage unit 120 (storage medium) and the communication unit 130, may electrically control the individual components, may be an electric circuit that executes software commands, and may perform various types of data processing and determination to be described later. The processor 110 may be, for example, an electronic control unit (ECU), a micro-controller unit (MCU), or another lower level controller that is mounted on a transportation system.

The storage unit 120 can be a storage medium that can store road information and an algorithm executed by the processor. The road information may include map information, road traffic condition information, and/or the like. Depending on the configuration of the driving information display apparatus 101 of the present disclosure, the form or amount of road information stored inside the driving information display apparatus 101 may vary.

In some cases, the storage unit 120 may store road information including the map information and traffic condition information of all serviceable areas and provide services based on the road information. Alternatively, the storage unit 120 may temporarily store only road information related to a location where guidance is being made and provide services based on the temporarily stored road information.

This may be implemented as a different form depending on the form in which the driving information display apparatus 101 according to an example embodiment of the present disclosure is implemented inside or outside a transportation system, the communication method used, the storage space of the storage unit 120, and/or input/output speed. This is a part that may be chosen autonomously by those skilled in the art depending on the implementation situation. The scopes of rights of the present disclosure are not necessarily limited by such changes in implementations.

The road information stored in the storage unit 120 may include not only general road information but also information for the provision of guidance on entrances, exits, parking locations, and/or the like within indoor sections such as underground parking lots.

The road information stored in the storage unit 120 may include various types of display information to be displayed in guidance information. The display information may include various types of information to be included in the guidance information displayed in driving situations, such as intersections, traffic lights, crosswalks, destinations, and major landmarks. The display information included in the road information may include parking locations, entrance locations, ramps for movement between floors, indoor facilities, road information outside indoor sections connected to exits, and/or the like for the purpose of guidance inside indoor sections. Such display information may each be composed of a combination of the name of the display information to be displayed as guidance information and information related to the location where the corresponding display information can be displayed.

The storage unit 120 may have various forms, and may be at least one type of storage medium such as a flash memory-, hard disk-, micro-, card (e.g., secure digital (SD) card)-, extreme digital (XD) card-, random access memory (RAM)-, static RAM (SRAM)-, read-only memory (ROM)-, programmable ROM (PROM)-, electrically erasable PROM (EPROM)-, magnetic memory (MRAM)-, magnetic disk-, or optical disk-type storage medium, or the like, or any combination thereof, for example. Depending on the amount, processing speed, storage time, and/or the like of data to be stored, a different type of storage medium or a combination of different types of storage media may be chosen.

The algorithm stored in the storage unit 120 may be implemented as a computer program in an executable form, and may be implemented to be stored in the storage unit 120 and then executed in a required situation. The algorithm stored in the storage unit 120 may be interpreted as including an instruction form that is temporarily loaded into volatile memory and instructs the processor to perform specific operations.

The communication unit 130 can receive information for driving guidance from the outside of the driving information display apparatus 101 of the present disclosure over a wired/wireless communication network, and transmits necessary information to an external module.

The communication unit 130 may receive road information stored in the storage unit 120, an algorithm executed by the processor 110, and the like from an external module, and may transmit information related to the current state of a transportation system to the outside to obtain necessary information related to the transmitted information. For example, the communication unit 130 may continuously receive traffic information from a traffic information server to check real-time traffic information, and can be configured to transmit the location and route information of a transportation system, found through a module such as a Global Positioning System (GPS) receiver, to the outside to obtain the real-time traffic information of an area related to the location and route of the transportation system.

The communication unit 130 can be a hardware device that is implemented using various electronic circuits to transmit and receive signals over a wireless or wired connection. In an example embodiment of the present disclosure, the communication unit 130 may perform communication within a transportation system using infra-transportation means network communication technology, and may perform Vehicle-to-Infrastructure (V2I) communication with a server, infrastructure, another transportation system, and/or the like outside a transportation system using wireless Internet access or short-range communication technology. The communication within a transportation system may be performed using Controller Area Network (CAN) communication, Local Interconnect Network (LIN) communication, FlexRay communication, and/or the like as the infra-transportation means network communication technology. Such wireless communication technology may include wireless LAN (WLAN), Wireless Broadband (WiBro), Wi-Fi, Worldwide Interoperability for Microwave Access (WiMAX), etc. Moreover, the short-range communication technology may include Bluetooth, ZigBee, Ultra-wideband (UWB), Radio Frequency Identification (RFID), Infrared Data Association (IrDA), etc.

The output unit 140 may output augmented reality information that is controlled by executing the algorithm, stored in the storage unit 120, by the processor 110. Augmented reality is a technology for enabling related information to be provided by adding graphic information to an image or scene of the real world.

The output unit 140 may be implemented as a head-up display (HUD), a cluster, an audio, video and navigation (AVN) system, a human-machine interface (HMI), and/or the like. The output unit 140 may include at least one of a liquid crystal display (LCD), a thin film transistor liquid crystal display (TFT LCD), a light emitting diode (LED) display, an organic light emitting diode (OLED) display, an active matrix OLED (AMOLED) display, a flexible display, a bended display, and a three-dimensional (3D) display. Some of these displays may be implemented as a transparent display configured in a transparent or translucent form to be able to view the outside thereof. The output unit 140 may be provided as a touch screen including a touch panel, and may be used as an input device as well as an output device.

In the present disclosure, the vehicle may be described as being based on a concept including various transportation systems. In some cases, the vehicle may be interpreted as being based on a concept including not only various means of land transportation, such as cars, motorcycles, trucks, and buses, which drive on roads, but also various transportation systems, such as airplanes, drones, ships, etc.

Accordingly, in the present disclosure, the electric vehicle may be interpreted as being based on a concept including various transportation systems that store electric energy in a secondary battery and use it as a power source among various transportation systems.

The driving information display apparatus 101 according to an embodiment of the present disclosure may have different example embodiments depending on the driving guidance information processed by the processor 110. Accordingly, the generation of the driving guidance information received by the processor 110 and the information included in the driving guidance information will be described by way of example below.

As described above, the processor 110 can perform control to receive driving guidance information and information related to the location of an electric vehicle and output a guidance screen corresponding to the driving guidance information. The driving guidance information may include a variety of types of information. When a driver sets a destination and wants to receive guidance information related to it through a screen, the driving guidance information may include information related to the destination and a route leading to the destination. Various types of other information for the driving guidance of a vehicle may be included in the driving guidance information.

In particular, in the case of an electric vehicle, the driving distance is short, charging takes a long time, and there are not a sufficient number of charging stations, so that it is important to provide guidance on an optimal route passing through a charging station during route guidance. Accordingly, the processor 110 may be configured to provide guidance on an optimal route along which a driver may safely drive to a destination while charging an electric vehicle at a necessary point by using electric vehicle charging station information included in the map information stored in the storage unit 120.

The driving guidance information may be information received from a driving information management server 102 through the communication unit 130, or may be information derived by the processor 110 through its own computation process. The driving guidance information can include route information that can provide guidance on whether a driver will pass through a charging station when driving an electric vehicle to a destination and provide guidance on the charging station through which the driver will pass when he or she will pass through the charging station.

When such route information is included in the driving guidance information, the processor 110 can perform control to display a route on the map information stored in the storage unit 120 and output the map information through the output unit 140.

The driving guidance information can include route information including a passage via a charging station that can be generated by deriving a driving type based on driving information including the destination of the electric vehicle, deriving a weight for each charging factor based on the driving information, and using the derived driving type and the derived weight for each charging factor.

The driving type can represent the purpose and circumstances under which the electric vehicle is driven to its current destination. For example, the driving type may be basically classified as one-way driving or round-trip driving. One-way driving may be classified as short-distance driving, intermediate-distance driving, or long-distance driving depending on the driving distance. The intermediate-distance driving may be defined as driving for a same-day driving schedule, and the long-distance driving may be defined as driving for a one- or more-night driving schedule.

In a case where a driving type can be accurately identified when a driver starts driving by entering a destination into an electric vehicle, different route guidance may be provided depending on the driving type. For example, when the destination entered by the driver is determined to correspond to a round-trip driving type, there may be provided route guidance that allows an appropriate remaining charge level to remain when the driver returns to a starting point by considering the route from the starting point through the destination to the starting point.

When a route is provided by considering only the driving from a starting point to a destination, guidance can be provided to allow an appropriate remaining battery charge level to remain when an electric vehicle arrives at the destination. Accordingly, it can be difficult to provide route guidance that considers the next driving.

For example, in the case where the minimum remaining charge level is 30% of a total battery capacity, when a battery charge level is expected to be 20% upon arrival at the destination entered by a driver, guidance can be provided to drive to a charging station, charge an electric vehicle with electricity corresponding to 10% of the total battery capacity, and then move to satisfy the minimum remaining charge level.

However, in a case of round-trip driving in which an electric vehicle arrives at a destination and returns to a starting point immediately after a short period of time, return driving starts in the state of 30% of the total battery capacity, so that the electric vehicle needs to visit a charging station and be recharged with electricity again. There can be the inconvenience of having to pass through the charging station twice during a round trip.

In a case where it is possible to predict that current driving is round-trip driving, when it is possible to predict a charge level sufficient to safely complete return driving and guide a driver to visit a charging station and charge an electric vehicle to the predicted charge level, it can be possible to perform driving to satisfy the minimum remaining charge level when returning to a starting point after completing a round trip with only one stop at a charging station.

The driving type may be configured to be derived by inputting the driving information of the electric vehicle into a personalized artificial intelligence model that can be generated by performing training using the past driving information of the driver of the electric vehicle as training data. The past driving information may include information that relates to starting points, destinations, driving distances, departure days, departure time spans, and/or the like. In other words, driving information can be accumulated in a database whenever a driver drives an electric vehicle, information related to the driving type, such as round-trip driving, long-distance one-way driving, or short-distance one-way driving, can be stored together with the driving information, and a personalized driving-type artificial intelligence model may be generated by performing training using these types of information as training data.

For example, in a case where a driver starts driving on Monday morning with a starting point being home and a destination being work and a driving distance is 5 km, when the next driving performed immediately after the current driving is driving on the same evening with a starting point being work and a destination being home, it can be determined that the driving type of the morning driving is round-trip driving, particularly outgoing driving, and the driving type can be stored in the database together with driving information.

When such data is accumulated over a long period of time, sufficient data to train a personalized driving-type artificial intelligence model that can predict a driving type based on driving information such as a user's starting point, destination, driving distance, departure day, and time span can be accumulated in the database.

A variety of artificial intelligence algorithms may be used to generate the personalized driving-type artificial intelligence model. A regression algorithm such as a random forest regressor and a neural network such as deep learning may be used. The present disclosure is not necessarily limited to a specific artificial intelligence algorithm.

When the driving type may be predicted using this personalized driving-type artificial intelligence model, more effective route guidance may be provided based on the predicted driving type.

The weight for each charging factor may include a weight for a charging type (or charging speed) indicative of whether charging in question is fast charging or slow charging, a weight for charging time, and a weight for a charging location (a starting point, a destination, or a passage point). For example, when it is determined that it is desirable to charge an electric vehicle as much as possible at a starting point for a long period of time using fast charging and then depart by considering a current driving situation, a higher weight can be assigned to fast charging, the charging time can be set to a longer value, and a higher weight can be assigned to a starting location as the charging location.

When charging information suitable for a current situation and a driver's tendencies is generated using the weight for each charging factor in this manner, route guidance may be generated based on the charging information.

The weight for each charging factor may be derived by entering the driving information of the electric vehicle into a personalized charging-factor artificial intelligence model that can be generated by performing training using the past driving information of the driver of the electric vehicle as training data. In other words, when driving information such as starting points, destinations, driving distances, departure days, departure time spans, and/or the like is organized into a database and information related to a charging location (a starting point, a destination, or a passage point), charging speed, and charging time during corresponding driving is stored in association with a corresponding piece of driving information, there may be generated a personalized charging-factor artificial intelligence model that can predict a charging method during current driving suitable for a driver's tendencies using current driving information as an input value.

When the driving type and the weight for each charging factor are determined in this manner, a remaining charge level at the destination can be determined using the driving type and the weight for each charging factor derived as described above, and route information including a passage via a charging station can be generated to satisfy the determined remaining charge level at the destination.

The operation of determining the driving type and the weight for each charging factor and generating route information in this manner may be performed in a driving information management server 201 connected to the driving information display device 101 of the present disclosure over a communication network. The driving information display device 101 can receive the generated route information and provides it to the driver as driving guidance information.

The remaining charge level at the destination can be determined by predicting the driving next to current driving based on the driving type and reflecting information related to the predicted next driving. In other words, when the driving type is a round-trip type, route guidance can be generated so that the remaining charge level can be maintained above the minimum charge level even after driving along an overall route, including a route for return driving. In the case of a one-way type, route information may be generated by considering the case of using the next charging station.

When the driving type is a one-way type, the remaining charge level at a destination may be determined so that the minimum remaining charge level can be maintained even after additional traveling from the destination to the nearest charging station. In other words, a route may be set so that the driver can safely arrive at the next charging station when it is necessary to charge the electric vehicle for the next driving after arrival at the destination.

When it is possible to predict the next destination after arrival at the destination, a route may be set so that the minimum remaining charge level is maintained after moving to the nearest charging station on a route to the next destination.

When a slow charger or fast charger is installed at a destination, charging may be performed before the start of the next driving from the destination, so that route guidance may be provided to keep the remaining charge level at the destination lower.

The driving route can include information related to a charging station and the amount of electricity for charging. When the charging time increases at a charging station located at a passage point, a problem can arise in that the overall driving time can increase. Accordingly, there can be needed route guidance that satisfies a remaining charge level at a destination while minimizing charging time at a charging station located at a passage point.

Accordingly, it can be desirable to generate a database into which information related to whether a charging station is present at a destination and whether the charging station is fast or slow is organized and use this database when generate a driving route.

The remaining charge level at a destination may be determined so that, when the driving type is round-trip driving, the minimum remaining charge level can remain even after return driving has been completed. In a case of round-trip driving, when sufficient charging is performed before departure or at a passage point to maintain the minimum remaining charge even after returning to a starting point, the inconvenience of having to pass through a charging station due to a low charge level again may be avoided during return driving.

In a case where in round-trip driving, there is a charger at a destination, and when it is possible to obtain information indicating whether an electric vehicle will stay at the destination long enough to be charged with electricity, the battery state of an electric vehicle when return driving starts may be predicted, and more efficient route guidance may be generated.

As for information related to the period for which a driver will stay at a destination during a round-trip drive, when the time for which a driver stays at a destination in the case of a round-trip drive for each piece of driving information is recorded in a database in which past driving information is accumulated as described above, there may be generated an artificial intelligence model that predicts the time spent at the destination when driving information is entered based on the above database.

For example, when a driver uses an electric vehicle to commute to work, there can be a time equivalent to working hours between outgoing driving to work and incoming driving from work. When a database in which this type of time information has been accumulated for a long period of time is learned, it may be possible to predict how long the driver will stay at his or her destination when he or she goes to work in the morning. When the driver is expected to stay at the destination for eight hours and there is a slow charger at the destination, the amount of electricity with which an electric vehicle can be charged using the slow charger during his or her stay at the destination can be calculated. When this is calculated as the starting capacity of return driving, more accurate route information may be generated.

When the driver performs operation in conjunction with a personal schedule database 202, the driving type may be identified and the next driving may be predicted by considering the driver's schedule. For example, when the driver sets a destination as work in the morning, it may be possible to recognize it as round-trip driving between home and work if there is no separate schedule. When a schedule to drive to another location after work hours is stored in the personal schedule database, it may be determined to be a one-way schedule rather than a round-trip schedule.

When a location is set in a stored schedule, a remaining charge level at a destination can be set by considering movement to that location, through which efficient route guidance can be provided. In other words, it may be possible to determine the driving type to be one-way driving and set the remaining charge level at a destination to a value sufficient to maintain the minimum remaining charge level upon movement to the nearest charging station on a route to the location stored in the schedule. It may also be possible to determine the remaining charge level at a destination so that the minimum remaining charge level can be maintained upon movement to the location stored in the schedule without driving via a charging station.

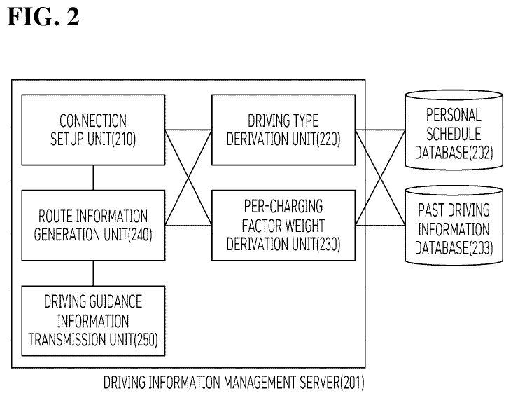

FIG. 2 is a block diagram showing the internal configuration of a driving information management server according to various example embodiments of the present disclosure.

The driving information management server 201 according to various example embodiments of the present disclosure can be a server equipped with a central processing unit (CPU) and memory (storage medium), and may include a standalone server and/or a cloud. The driving information management server 201 is not necessarily limited to a specific configuration as long as the driving information management server 201 can obtain a target remaining battery charge level by processing the information received from the above-described driving information display apparatus 101 over a wired or wireless communication network and transmit the target remaining battery charge level back to the driving information display apparatus 101 over a communication network, for example.

The driving information management server 201 of an embodiment of the present disclosure can process the computation that can be required to generate the charging guidance information displayed on the driving information display apparatus 101. Accordingly, the process of generating charging guidance information in the driving information display apparatus 101 described above may be performed in the driving information management server 201. Therefore, the descriptions of the process of generating charging guidance information displayed on the driving information display apparatus 101 may be applied to the driving information management server 201 without significant change, and vice versa, for example.

As shown in the drawing, the driving information management server 201 may include a connection setup unit 210, a driving type derivation unit 220, a per-charging factor weight derivation unit 230, a route information generation unit 240, and a driving guidance information transmission unit 250. The individual components may be configured as software components that run within the above-described server apparatus, and may be subject to various modifications.

The connection setup unit 210 can set up connections to exchange information with the driving information display apparatuses 101 of a plurality of electric vehicles. The connection setup unit 210 can set up connections with the communication units 130 of the driving information display apparatuses 101 over a wired or wireless communication network, and is not necessarily limited to a specific type of communication.

The driving type derivation unit 220 can derive a driving type based on driving information including the destination of an electric vehicle received from the electric vehicle.

As described above, the driving type can represent the purpose and circumstances under which the electric vehicle is driven to its current destination. For example, the driving type may be basically classified as one-way driving or round-trip driving. One-way driving may be classified as short-distance driving, intermediate-distance driving, or long-distance driving depending on the driving distance. The intermediate-distance driving may be defined as driving for a same-day driving schedule, and the long-distance driving may be defined as driving for a one- or more-night driving schedule.

In a case where a driving type can be accurately identified when a driver starts driving by entering a destination into an electric vehicle, different route guidance may be provided depending on the driving type. For example, when the destination entered by the driver is determined to correspond to a round-trip driving type, there may be provided route guidance that can allow an appropriate remaining charge level to remain when the driver returns to a starting point by considering the route from the starting point through the destination to the starting point.

The driving type derivation unit 220 can accumulate driving-related information such as a starting point, a destination, a driving distance, a departure day, and a departure time span, and surrounding situation information such as weather in a past driving information database 203 for each drive, determine a driving type by checking the next driving information after the drive, and then store information related to the driving type of the driving. When the driving type of the corresponding driving together with the driving-related information and the surrounding situation information is stored in the past driving information database 203 in this manner and an artificial intelligence model is generated by performing training using the accumulated data as training data, a personalized driving-type artificial intelligence model may be generated.

The driving type derivation unit 220 can obtain a prediction result for the driving type by inputting the driving information of an electric vehicle into the personalized driving type artificial intelligence model generated in this manner.

When operation is performed in conjunction with the personal schedule database 202 of the driver, the driving type derivation unit 220 may be trained on information related to the driver's schedules before and after driving and information related to a travel location for each schedule, and may predict the driving type through the consideration of the driver's schedule by using information related to the driver's schedule during the current driving as input data.

For example, even when a driver drives to work in the morning as usual, a case where the driver has a plan somewhere else after work and a case where the driver returns home right away can be distinguished from each other through personal schedule information. Depending on the type or location of the schedule, it can be predicted whether the driver will take the vehicle with him or leave the vehicle for a while for a schedule and then return home. Accordingly, more efficient route guidance may be provided.

This prediction of the driving type can be based on a driver's personalized habits, so that it may increase accuracy but may not have 100% accuracy. Accordingly, the driving information display apparatus 101 of the present disclosure may provide the predicted driving type to the driver, may receive confirmation from the driver, and may generate more accurate route guidance.

The per-charging factor weight derivation unit 230 can derive a weight for each charging factor based on the driving information. The weight for each charging factor may include a weight for a charging type (or charging speed) indicative of whether charging in question is fast charging or slow charging, a weight for charging time, and a weight for a charging location (a starting point, a destination, or a passage point). For example, when it is determined that it is desirable to charge an electric vehicle as much as possible at a starting point for a long period of time using fast charging and then depart by considering a current driving situation, a higher weight can be assigned to fast charging, the charging time can be set to a longer value, and a higher weight can be assigned to a starting location as a charging location.

When charging information suitable for a current situation and a driver's tendencies is generated using the weight for each charging factor in this manner, route guidance may be generated based on the charging information.

The per-charging factor weight derivation unit 230 can derive the weight for each charging factor by entering the driving information of the electric vehicle into the personalized charging-factor artificial intelligence model that can be generated by performing training using the past driving information of the driver of the electric vehicle as training data. As described above, various types of information, such as driving information and surrounding situation information during past driving, can be accumulated and stored in the past driving information database 203. Information related to how the driver charged the electric vehicle at a starting point, destination, or passage point for each drive can be also stored.

In this manner, information related to charging factors for a corresponding drive may be stored together with driving information and surrounding situation information, and a personalized charging-factor artificial intelligence model may be generated using the accumulated data as training data. When current driving information and surrounding information are entered into the generated personalized charging-factor artificial intelligence model, weights for charging factors during a current drive may be predicted, and route guidance may be provided using these weights.

In a case where operation can be performed in conjunction with the personal schedule database 202 when the personalized charging-factor artificial intelligence model is trained, a driver's schedule before or after driving may be set as a parameter. The driver's charging type may vary depending on whether the driver has a schedule, so that more accurate customized guidance for each situation can be provided when the driver's schedule is also considered.

The personalized driving-type artificial intelligence model and the personalized charging-factor artificial intelligence model used in the driving type derivation unit 220 and the per-charging factor weight derivation unit 230, respectively, in this manner can be generated using the data accumulated in the personal schedule database 202 and the past driving information database 203, as training data. Because the individual models can be somewhat different from each other in terms of the characteristics thereof, it can be necessary to select information suitable for the generation of each of the prediction models from the stored information and use it as training data and input data.

A variety of artificial intelligence algorithms may be used to generate the personalized driving-type artificial intelligence model and the personalized charging-factor artificial intelligence model. A regression algorithm such as a random forest regressor and a neural network such as deep learning may be used. The present disclosure is not necessarily limited to a specific artificial intelligence algorithm.

The route information generation unit 240 can generate route information including a passage via a charging station generated using the derived driving type and the derived weight for each charging factor. When the route information for an electric vehicle is generated, guidance can be provided so that the remaining charge level when arriving at the destination remains above a set level. Conventionally, the target remaining charge level at the destination can be set to a specific value in a battery output stability area (a plateau), which can correspond to the range of 30% to 70% of the remaining battery charge level of the electric vehicle. Guidance on charging at a starting point or charging via a charging station can be provided to satisfy this requirement.

However, when route guidance is provided according to the same criteria regardless of the driving type or driver's tendencies, the driver may feel uncomfortable, especially during the next drive.

Accordingly, the route information generation unit 240 does not simply satisfy a target remaining charge level at a destination set in an electric vehicle, but can determine the target remaining charge level at a destination using the derived driving type and the derived weight for each charging factor. The route information generation unit 240 can generate the route information including a passage via a charging station to satisfy the target remaining charge level at a destination.

This can make it possible to provide route guidance suitable for the driving type and the driver's charging tendencies. There may be provided route guidance that considers not only current driving, but also the next driving or future driving. Accordingly, the convenience of the driver may be maximized. In particular, route guidance can provide guidance on a charge level, such as a charge level before departure, a charge level at a charging station during a drive, or a charge level at a destination, as well as various types of guidance such as charging time and charging speed. Accordingly, the driver can be enabled to conveniently drive the electric vehicle.

The route information generation unit 240 can predict the driving next to current driving based on the driving type, and determine the remaining charge level at a destination by reflecting information related to the predicted next driving therein. Even when a drive has the same starting point and destination, route guidance may vary completely depending on whether the purpose of driving is round-trip driving or one-way driving. In a case of round-trip driving, it can be desirable to provide guidance so that an electric vehicle can return to an original starting point without frequent additional charging. In a case of one-way driving, it can be desirable to provide guidance to maintain a charge level to avoid inconvenience during the next drive.

The route information generation unit 240 can determine the remaining charge level at a destination so that the minimum remaining charge level can remain even after additional deriving from the destination to the nearest charging station. When the next location to move to is not predicted after arrival at the destination, a determination may be made based on the closest charging station in terms of distance. When a location to move to after arrival at the destination may be predicted based on information such as the driver's schedule, a determination may be made based on the nearest charging station on a route to the location. When charging is possible at the destination, an electric vehicle may be guided to arrive at the destination while maintaining the minimum remaining charge level. The minimum remaining charge level may be set to about 30% of the total battery capacity so that the range maintains a battery output stable region (a plateau) as described above. In some cases, the minimum remaining charge level may be set based on the drivable distance.

When the driving type is round-trip driving, the route information generation unit 240 can determine the remaining charge level at a destination so that the minimum remaining charge level can remain even after return driving. In a case of one-way driving, the minimum remaining charge level may be maintained at a destination or until the electric vehicle arrives at the next charging station after arrival at the destination. In a case of round-trip driving, when the minimum remaining charge level can be maintained even after the completion of return driving, round-trip driving may be comfortably performed without charging in the middle of the driving.

The driving guidance information transmission unit 250 can transmit driving guidance information including the generated route information to the electric vehicle. The communication unit 130 of the driving information display apparatus 101 of the electric vehicle transfers the driving guidance information, transmitted in this manner, to the processor 110, and the processor 110 can perform control so that the output unit 140 outputs a guidance screen corresponding to the driving guidance information.

The driving information management server 201 may continuously collect driving-related information such as starting points, destinations, driving distances, departure days, and departure times and information such as charging types (high charging or slow charging), charging locations, and charging times upon charging from the driving information display apparatuses 101 of a plurality of electric vehicles to maintain the past driving information database 203 and generate training data through it.

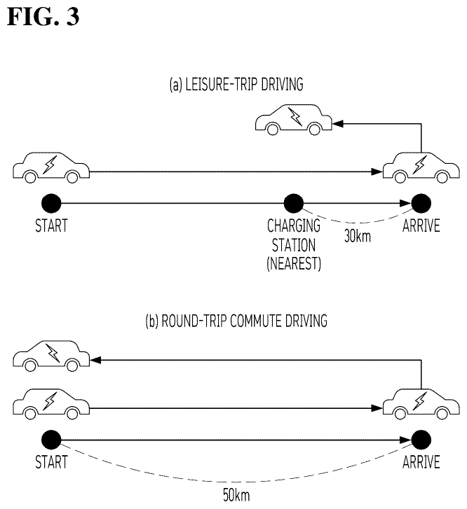

FIG. 3 is a diagram showing an example of determining a remaining charge level at a destination according to a driving type in a driving information display apparatus according to various example embodiments of the present disclosure.

Case (a) of FIG. 3 shows route guidance when the driving type is determined to be leisure-trip driving included in one-way driving. As shown in the drawing, in a case where the driving type is determined to be one-way driving when driving guidance is received by entering a destination at a starting point, the minimum remaining charge level can be not maintained upon arrival at the destination, unlike in the past, but the remaining charge level at a destination can be determined to be a level that allows safe driving to the nearest charging station where charging can be performed during the next drive after the arrival at the destination.

In the drawing of case (a) in FIG. 3, the nearest charging station is 30 km away upon arrival at a destination, and thus the remaining charge level at the destination can be determined to be a charge level that allows an electric vehicle to drive 30 km further than the minimum remaining charge level upon arrival at the destination. To satisfy this requirement, the driving information display apparatus 101 may guide a driver to charge an electric vehicle more sufficiently before departure, or may guide a driver to select a charging station that can be conveniently used during a drive, stop by the charging state, and charge an electric vehicle.

When a charging station where an electric vehicle can be charged with electricity present at a destination, it may be sufficient to provide guidance to maintain a charge level equal to or higher than the minimum remaining charge level at the destination. However, when the driver's pattern or schedule information can be searched for, it may be determined whether the driver will stay at the destination long enough to charge the electric vehicle and then depart again, and different route guidance may be provided.

For example, when a destination is provided with a slow charger but a driver usually stays within 10 minutes and departs immediately, it can be difficult to determine that the driver will charge the vehicle sufficiently and then move. Accordingly, route guidance may be set differently by considering the charging speed information of the destination and the predicted time from arrival at the destination to the next drive.

Case (b) of FIG. 3 shows a case where the driving type is reciprocating commute driving, which can be determined to be round-trip driving. As shown in the drawing of case (b) in FIG. 3, when a driver reciprocates along a one-way distance of 50 km every day, it can be predicted that when a destination is entered at a starting point, the driver will return to the starting point.

In a case of round-trip driving that is expected to return to a starting point, route guidance can be provided to guide pre-charging or passage-point charging so that the minimum remaining charge level can be maintained upon return to the starting point. In the drawing of case (b) of FIG. 3, the driver can be expected to drive 50 km and then return to a starting point, so that route guidance can be provided so that a charge level that allows an electric vehicle to drive 50 km further than the minimum remaining charge level can remain upon arrival at the destination.

In this manner, in a case of round-trip driving, when an electric vehicle starts in the state of being sufficiently charged with electricity in advance or stops by a charging station and is sufficiently charged with electricity, the inconvenience of visiting charging stations unnecessarily can be prevented and efficient driving is enabled.

In a case where it is determined that the driving type is round-trip driving, when there is a charging station by which an electric vehicle can stop in the middle of the driving, one method may be selected between charging on an outgoing drive and charging on a return drive. Desirable charging time, a desirable charging location, and a desirable charge level may be determined using information related to a weight for each charging factor predicted through the artificial intelligence model, and route guidance including a passage through a charging station may be generated with the weights reflected therein.

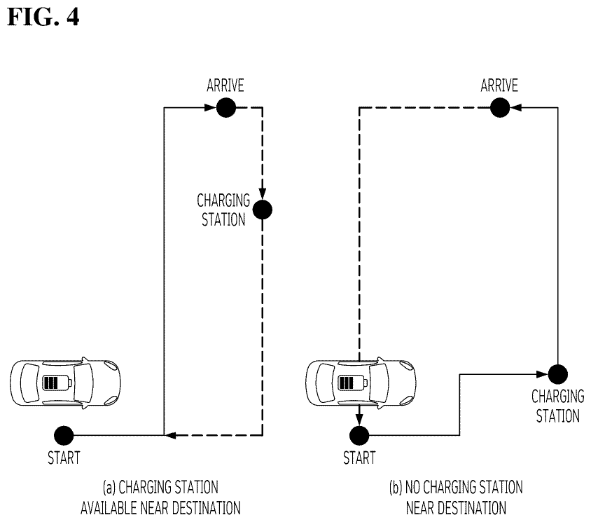

FIGS. 4 to 7 are diagrams showing examples in which route guidance can vary depending on the situation in a driving information display apparatus according to various example embodiments of the present disclosure.

In each of the drawings, the route indicated by each solid line represents the route through which an electric vehicle is guided during a current drive, and the route indicated by each dotted line represents the route through which an electric vehicle is expected to be guided during the next drive after the completion of the current drive.

FIG. 4 is a diagram showing an example of route guidance that varies depending on the presence/absence of a charging station near a destination in a driving information display apparatus according to various example embodiments of the present disclosure.

Even when an electric vehicle drives the same distance in the same charging state, route guidance may vary depending on whether there are multiple charging stations near a destination in a current driving situation.

In the drawing of FIG. 4, the case of round-trip driving intended to return to a starting point is used as an example. Even in the case of one-way driving, information related to the status of charging stations near a destination may be utilized.

When there is a charging station close to a destination, as shown in case (a) of FIG. 4, it can be easy to return via the charging station on the next drive. Accordingly, convenient round-trip driving can be performed in such a manner that an electric vehicle is guided to drive to a destination without stopping by a charging station and then pass through a charging station on the way back to a starting point.

Whether to charge an electric vehicle on an outgoing drive or on a return drive can be determined based on the analysis results of the personalized charging-factor artificial intelligence model that can be generated by reflecting a driver's usual habits.

In contrast, when there is no charging station near a destination, as shown in case (b) of FIG. 4, a problem may occur when an electric vehicle drives to a charging station on a return drive. Accordingly, an electric vehicle may be guided to stop by a charging station and be charged with electricity in advance, or may be guided to maintain a higher charge level upon departure, as shown in the drawing of FIG. 4.

According to the prior art, the next driving situation may be not taken into consideration. Accordingly, in both cases, an electric vehicle can be guided to either drive via a charging station in advance or not to drive via a charging station in advance in the same manner. In contrast, using an embodiment of the present disclosure, charging availability during the next drive can be taken into consideration, so that route guidance can vary depending on the situation and the driver can receive optimized route guidance.

Various methods according to an embodiment of the present disclosure may be applied to actually implement this. A first method can be to enter, as training data, training data to the artificial intelligence model that derives a weight for each charging factor for the status of charging stations near a destination. Route guidance may be provided with a driver's preferred charging method reflected therein depending on the status of charging stations near a destination.

In another method, when the remaining charge level at a destination is set, the remaining charge level at a destination may be set to allow an electric vehicle to move further than the minimum remaining charge level by the distance to the nearest charging station available after arrival at the destination, as described above.

In this manner, in the case where the remaining charge level at a destination is set by considering movement to the nearest charging station, when there is a charging station near a destination, as shown in case (a) of FIG. 4, guidance on driving via a charging station may not be provided during a current drive. In contrast, when there is a charging station far away from a destination, as shown in case (b) of FIG. 4, an electric vehicle may be guided to charge itself to a higher level in advance and then travel to the destination.

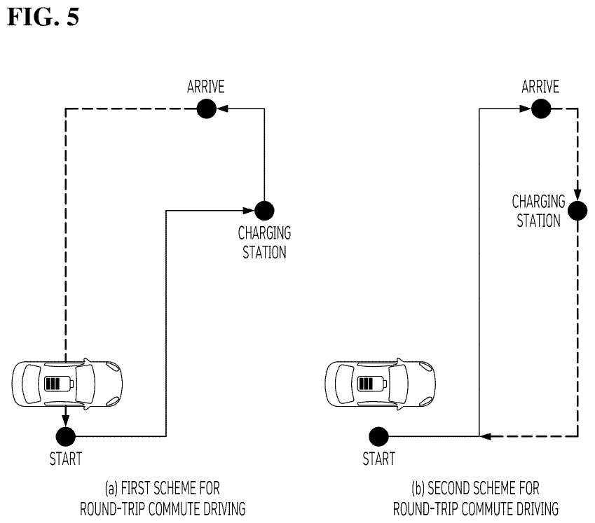

FIG. 5 is a diagram showing an example of route guidance that varies depending on the situation during a round-trip commute drive in a driving information display apparatus according to various example embodiments of the present disclosure.

As described above, in a case where the driving type is determined to be round-trip driving, when one passage via a charging station is required to complete round-trip driving, one method may be selected between charging on an outgoing drive and charging on a return drive.

When guidance is provided so that the minimum remaining charge level is simply maintained at a destination as in the prior art, there may occur an inconvenient situation in which an electric vehicle needs to pass through a charging station both on an outgoing drive and on a return drive. Accordingly, using an embodiment of the present disclosure, even when any one method is selected, an electric vehicle may be driven conveniently, in contrast to the prior art. However, using an embodiment of the present disclosure, a driver's usual charging patterns can be organized into a database, a personalized charging factor weight artificial intelligence model can be generated by training on the database, the driver's usual preferences for a charging location, charging speed, and charging time can be determined, and then guidance on a route can be provided based on such information.

In a case of round-trip commute driving, some drivers may prefer to stop by a charging station and charge their electric vehicle with sufficient electricity for a round trip during rush hour, as shown in case (a) of FIG. 5. In contrast, some drivers may prefer to drive straight to work and stop by a charging station on a return drive, as shown in case (b) of FIG. 5.

This may be selected by determining the weights given to a charging location, a charging station, and a charging method in connection with the charging factor weights derived from the artificial intelligence model. The personalized charging-factor artificial intelligence model can be generated by training on a database in which the driver's driving and charging situations are accumulated. Accordingly, the selection can be made by reflecting the charging pattern according to the driver's driving situation therein.

Therefore, the driver may receive a route recommendation suitable for his or her pattern, and conveniently and efficiently drive his or her electric vehicle.

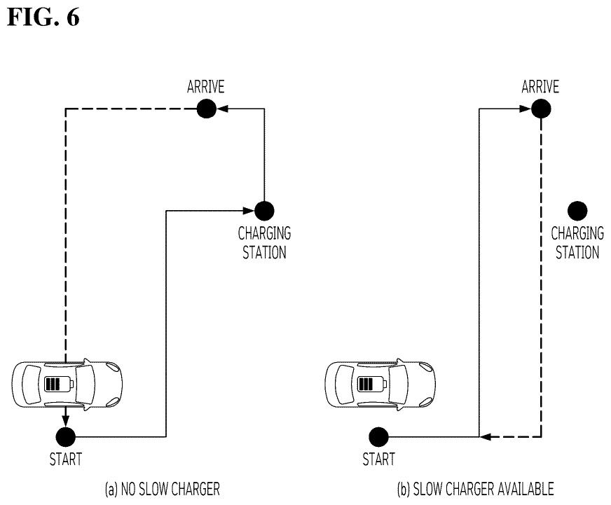

FIG. 6 is a diagram showing an example of route guidance that can vary depending on the presence/absence of a slow charger at a destination in a driving information display apparatus according to various example embodiments of the present disclosure.

The drawing of FIG. 6 shows cases where the driving type is round-trip driving. Case (a) of FIG. 6 shows a case where it can be determined that it can be desirable to stop by a charging station on an outgoing drive. However, when there is a slow charger at a destination, there can be no need to increase the remaining charge level at the destination via a charging station.

Therefore, as shown in case (b) of FIG. 6, the remaining charge level at a destination can be set to the minimum remaining charge level so that an electric vehicle can arrive at the destination immediately, and thus the electric vehicle can arrive at the destination safely.

When a driver does not stay at his or her destination long sufficiently to fully charge an electric vehicle, more sufficient pre-charging may be required even when a slow charger is present.

Accordingly, even when a slow charger is installed at a destination, route guidance may be set differently using information such as the charging speed of the slow charger and the estimated time for which the driver is expected to stay at the destination.

Information related to the slow charger present at the destination may be determined based on a database into which the charging information when the driver usually charges at the destination is organized. In a case of a place that the driver visits for the first time, the information related to the slow charger may be determined using information related to another driver's charging in that place.

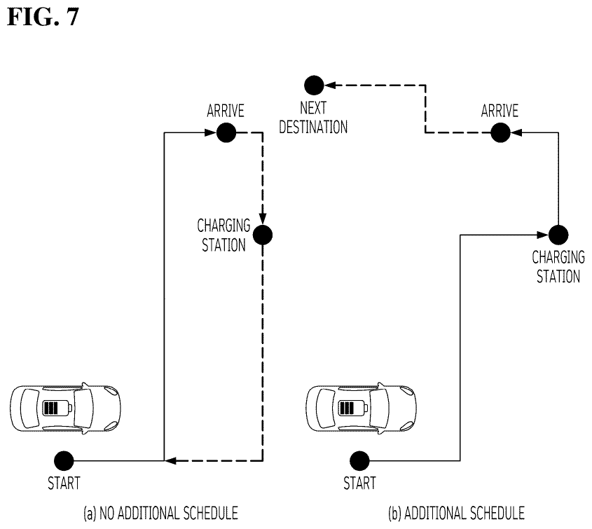

FIG. 7 is a diagram illustrating an example of route guidance that varies depending on the presence/absence of a schedule after arrival at a destination in a driving information display apparatus according to various example embodiments of the present disclosure.

The drawing of FIG. 7 shows an example in which route guidance can vary depending on a driver's schedule when the driving type is determined to be round-trip driving in a typical commute situation.

Case (a) of FIG. 7 is a case where the driver's another schedule is not identified, in which case route guidance may be provided by considering the round-trip driving type and the driver's charging pattern, as shown in the drawing.

In contrast, when the driver's schedule to move to another location is identified on his or her return drive (a drive from work to home), driving route may be guided by considering movement to the location included in the schedule information, as shown in case (b) of FIG. 7. In other words, the remaining charge level at a destination can be set by considering movement to the next destination rather than return to a starting point after arrival at the destination so that the minimum remaining charge level can be maintained upon arrival at the next destination. To satisfy this requirement, route guidance may be generated so that the driver charges an electric vehicle at a charging station in advance and then drive.

In this manner, even when driving having the same destination and starting point is performed, customized route guidance may be provided by considering a driver's various situations, making the efficient and comfortable driving of an electric vehicle possible.

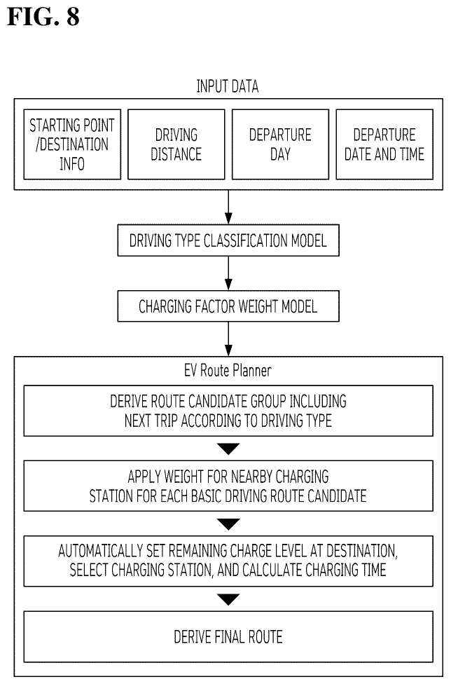

FIG. 8 is a diagram showing the flow of a process of generating route guidance by classifying a driving type and obtaining a weight for each charging factor in a driving information display apparatus according to various example embodiments of the present disclosure.

As shown in the drawing, using an embodiment of the present disclosure, training data can be generated by accumulating various types of data generated from driving situations such as starting point/destination information, driving distances, departure days, and departure times, and a model for classifying driving types and a model for obtaining weights for electric vehicle charging factors (electric vehicle features) can be generated using the training data.

Through this, route guidance can be generated by making a plan for the route of an electric vehicle. As shown in the drawings, route candidates including the next drive can be first derived according to classification results from the driving type classification model, thereby enabling route guidance that considers the situation of the next route.

In a case of a round-trip driving type or a situation in which an electric vehicle moves to another location after arrival at a destination, the remaining charge level at a destination can be determined by considering the corresponding driving, thereby supporting a driver to move as comfortably and fast as possible not only for the current driving to the destination entered by the driver, but also for an overall driving.

The charging factors for nearby charging stations can be analyzed for various route candidates derived according to the driving type, and weights derived from the model can be applied thereto. The remaining charge level at a destination can be changed and set by considering the driving type and various situations, and a charging station and a charge level at the charging station can be determined to achieve the remaining charge level at a destination.

Based on these details, a final electric vehicle driving path can be derived and driving guidance can be provided to a user.

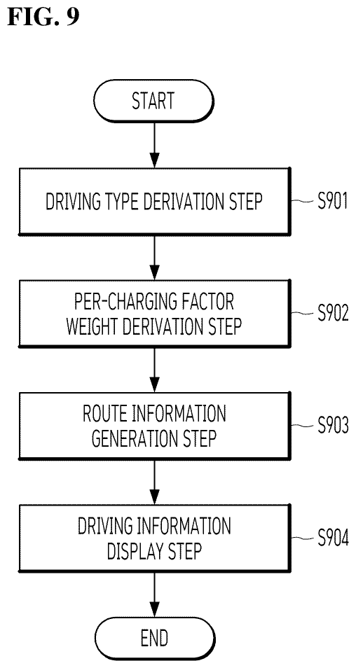

FIG. 9 is a flowchart showing the flow of a driving information display method according to various example embodiments of the present disclosure.

In an embodiment of the present example embodiment, the driving information display method can be a method that is performed by the driving information display apparatus 101 including the processor 110 and the storage unit 120 and/or the driving information management server 201. The components described above in conjunction with the operations of the driving information display apparatus 101 and/or the driving information management server 201 may be applied to the driving information display method without significant change. Accordingly, those skilled in the art may implement even the components, for which there are no specific descriptions in conjunction with the driving information display method below, by applying the foregoing descriptions of the driving information display apparatus 101 and the driving information management server 201.

In a driving type derivation step S901, a driving type can be derived based on driving information including the destination of an electric vehicle received from the electric vehicle.

In the driving type derivation step S901, the driving type can be derived by entering the driving information of the electric vehicle into a personalized driving-type artificial intelligence model that can be generated by performing training using the past driving information of the driver of the electric vehicle as training data.

In a per-charging factor weight derivation step S902, a weight for each charging element can be derived based on the driving information.

In the per-charging factor weight derivation step S902, the weight for each charging element can be derived by entering the driving information of the electric vehicle into a personalized charging-factor artificial intelligence model that can be generated by performing training using the past driving information of the driver of the electric vehicle as training data.

In a route information generation step S903, route information including a passage via a charging station can be generated using the derived driving type and weight for each charging factor.

In the route information generation step S903, the remaining charge level at a destination can be determined using the driving type and the weight for each charging factor derived above, and the route information including a passage via a charging station can be generated to satisfy the determined remaining charge level at the destination.

In the route information generation step S903, the next driving after the current driving can be predicted based on the driving type, and the remaining charge level at the destination can be determined by reflecting information related to the predicted next driving therein.

In the route information generation step S903, the remaining charge level at the destination can be determined so that the minimum remaining charge level can remain even after additional driving from the destination to the nearest charging station. When the driving type is round-trip driving, the remaining charge level at the destination may be determined so that the minimum remaining charge level can remain even after the completion of return driving.

In a driving information display step S904, driving guidance information including generated route information can be displayed. In the driving information display step S904, driving guidance information may be displayed directly on a display screen, or a control signal may be transmitted so that a separate device displays driving guidance information via a display screen.

An embodiment of the present disclosure may achieve the advantage of providing driving guidance information that enables comfortable driving by considering the remaining battery charge level of an electric vehicle.

An embodiment of the present disclosure may achieve the advantage of improving the overall convenience of driving of an electric vehicle by predicting not only driving to a destination, but also driving after arrival at the destination.

An embodiment of the present disclosure may achieve the advantage of predicting a driving type regarding whether current driving is round-trip driving or one-way driving by analyzing the driving patterns of each driver and providing route guidance appropriate for the driving type.

An embodiment of the present disclosure may achieve the advantage of providing customized route guidance according to circumstances such as a driver's next schedule even when the driver drives the same route.

Various advantages that may be directly or indirectly understood by those skilled in the art may be provided throughout the present specification.

Although the present disclosure has been described with reference to the example embodiments, those skilled in the art may variously modify and change an embodiment of the present disclosure without departing from the spirit and scopes of the present disclosure described in the attached claims.

The control device may be at least one microprocessor operated by a predetermined program that may include a series of commands for carrying out the method included in the aforementioned various example embodiments of the present disclosure.

In various example embodiments of the present disclosure, each operation described above may be performed by a control device, and the control device may be configured by a plurality of control devices, or an integrated single control device.

In various example embodiments of the present disclosure, the memory and the processor may be provided as one chip, or provided as separate chips.

In various example embodiments of the present disclosure, the scopes of the present disclosure can include software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various example embodiments of the present disclosure, the control device may be implemented in a form of hardware or software, or may be implemented in a combination of hardware and software.

The terms such as “unit,” “module,” etc. included in the specification can be units for processing at least one function or operation, which may be implemented by hardware, software, or a combination thereof.

In an example embodiment of the present disclosure, the vehicle may be referred to as being based on a concept including various transportation systems. In some cases, the vehicle may be interpreted as being based on a concept including not only various means of land transportation, such as cars, motorcycles, trucks, and buses, that drive on roads but also various transportation systems such as airplanes, drones, ships, etc.

For convenience in explanation and accurate definition in the appended claims, the terms “upper,” “lower,” “inner,” “outer,” “up,” “down,” “upwards,” “downwards,” “front,” “rear,” “back,” “inside,” “outside,” “inwardly,” “outwardly,” “interior,” “exterior,” “internal,” “external,” “forwards,” and “backwards” can be used to describe features of the example embodiments with reference to the positions of such features as displayed in the figures. It can be further understood that the term “connect” or its derivatives can refer both to direct and indirect connection.

The term “and/or” may include a combination of a plurality of related listed items or any of a plurality of related listed items. For example, “A and/or B” can include all three cases such as “A,” “B,” and “A and B.”

In the present specification, unless stated otherwise, a singular expression can include a plural expression unless the context clearly indicates otherwise.

In example embodiments of the present disclosure, “at least one of A and B” may refer to “at least one of A or B” or “at least one of combinations of at least one of A and B.” Furthermore, “one or more of A and B” may refer to “one or more of A or B” or “one or more of combinations of one or more of A and B.”

In the example embodiment of the present disclosure, it can be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific example embodiments of the present disclosure have been presented for purposes of illustration and description. They are not intended to be exhaustive or to necessarily limit the present disclosure to the precise forms disclosed, and many modifications and variations can be possible in light of the above teachings. The example embodiments were chosen and described to explain certain principles of the present disclosure and practical applications, to enable others skilled in the art to make and utilize various example embodiments of the present disclosure, as well as various alternatives and modifications thereof. It is intended that the scope of the present disclosure be defined by the Claims appended hereto and their equivalents.

What is claimed is:

1. A driving information display apparatus comprising:
one or more processors; and
a storage medium configured to store road information and an algorithm configured to run by the one or more processors, and storing computer-readable instructions that, when executed by the one or more processors, enable the one or more processors to:
perform control to receive driving guidance information and location information of an electric vehicle, and
output a guidance screen corresponding to the driving guidance information,
wherein the driving guidance information includes route information including a passage via a charging station that is generated by deriving a driving type based on driving information including a destination of the electric vehicle, deriving a weight for each charging factor based on the driving information, and using the derived driving type and the derived weight for each charging factor.

2. The apparatus of claim 1, wherein the route information is derived by determining a remaining charge level at the destination based on the derived driving type and the derived weight for each charging factor and including the passage via the charging station to satisfy the determined remaining charge level at the destination.

3. The apparatus of claim 2, wherein the remaining charge level at the destination is determined by predicting a next driving after a current driving based on the driving type and reflecting information related to the predicted next driving in the determining of the remaining charge level at the destination.

4. The apparatus of claim 3, wherein the remaining charge level at the destination is determined so that a minimum remaining charge level remains even after additional driving from the destination to a nearest charging station.

5. The apparatus of claim 3, wherein the remaining charge level at the destination is determined so that, in response to the driving type being a round-trip driving type, a minimum remaining charge level remains even after completion of return driving.

6. The apparatus of claim 1, wherein the driving type is derived by entering the driving information of the electric vehicle into a personalized driving-type artificial intelligence model that is generated by performing training using past driving information of a driver of the electric vehicle as training data.

7. The apparatus of claim 1, wherein the weight for each charging factor is derived by entering the driving information of the electric vehicle into a personalized charging-factor artificial intelligence model that is generated by performing training using past driving information of a driver of the electric vehicle as training data.

8. A driving information management server comprising:
a central processing unit; and
a memory configured to store instructions that, when executed by central processing unit, enable the central processing unit to:
set up connections to exchange information with driving information display apparatuses of a plurality of electric vehicles;
derive a driving type based on driving information including a destination received from a given electric vehicle of the plurality of electric vehicles;
derive a weight for each charging factor based on the driving information;
generate route information including a passage via a charging station generated using the derived driving type and the derived weight for each charging factor; and
transmit driving guidance information including the generated route information to the given electric vehicle.

9. The server of claim 8, wherein the instructions further enable the central processing unit to:
determine a remaining charge level at the destination based on the derived driving type and the derived weight for each charging factor; and
generate the route information including the passage via the charging station to satisfy the determined remaining charge level at the destination.

10. The server of claim 9, wherein the instructions further enable the central processing unit to:
predict a next driving after a current driving based on the driving type; and
determine the remaining charge level at the destination by reflecting information related to the predicted next driving in the determining of the remaining charge level at the destination.

11. The server of claim 10, wherein the instructions further enable the central processing unit to determine the remaining charge level at the destination so that a minimum remaining charge level remains even after additional driving from the destination to a nearest charging station.

12. The server of claim 10, wherein the instructions further enable the central processing unit to determine the remaining charge level at the destination so that, in response to the driving type being a round-trip driving type, a minimum remaining charge level remains even after completion of return driving.

13. The server of claim 8, wherein the instructions further enable the central processing unit to derive the driving type by entering the driving information of the given electric vehicle into a personalized driving-type artificial intelligence model that is generated by performing training using past driving information of a driver of the given electric vehicle as training data.

14. The server of claim 8, wherein the instructions further enable the central processing unit to derive the weight for each charging factor by entering the driving information of the given electric vehicle into a personalized charging-factor artificial intelligence model that is generated by performing training using past driving information of a driver of the given electric vehicle as training data.

15. A driving information display method, the method comprising:
deriving a driving type based on driving information including a destination of an electric vehicle received from the electric vehicle;
deriving a per-charging factor weight for each charging factor based on the driving information;
generating route information including a passage via a charging station generated using the derived driving type and the derived per-charging factor weight for each charging element; and
displaying driving guidance information including the generated route information.

16. The method of claim 15, wherein the generating of the route information comprises:
determining a remaining charge level at the destination based on the derived driving type and the derived per-charging factor weight for each charging factor; and
generating the route information including the passage via the charging station to satisfy the determined remaining charge level at the destination.

17. The method of claim 16, wherein the generating of the route information comprises:
predicting a next driving after a current driving based on the driving type; and
determining the remaining charge level at the destination by reflecting information related to the predicted next driving in the determining of the remaining charge level at the destination.

18. The method of claim 17, wherein the generating of the route information comprises determining the remaining charge level at the destination so that a minimum remaining charge level remains even after additional driving from the destination to a nearest charging station.

19. The method of claim 17, wherein the generating of the route information comprises determining the remaining charge level at the destination so that, in response to the driving type being a round-trip driving type, a minimum remaining charge level remains even after completion of return driving.

20. A non-transitory computer-readable storage medium having stored thereon a program that, when executed by a processor, causes the processor to execute the driving information display method of claim 15.
